(19) United States
(12) Patent Application Publication
(10) Pub. No.: US 2023/0318494 A1
(43) Pub. Date: Oct. 5, 2023

(54) METHOD FOR CONNECTING AN ELECTRIC ASYNCHRONOUS MACHINE OF A POWERTRAIN TO AN ELECTRIC GRID

(71) Applicant: Gerald HEHENBERGER, Klagenfurt (AT)

(72) Inventor: Gerald HEHENBERGER, Klagenfurt (AT)

(21) Appl. No.: 17/785,823

(22) PCT Filed: Dec. 16, 2020
(86) PCT No.: PCT/EP2020/086392

§ 371 Date: Dec. 6, 2022

(30) Foreign Application Priority Data
Dec. 16, 2019 (AT) A 00400/2019

(51) Int. Cl. H02P 5/753; F16H 1/28

(52) U.S. Cl. CPC H02P 5/753; F16H 1/28; H02J 3/00

(57) ABSTRACT

Disclosed is a method for connecting an electric asynchronous machine of a powertrain to an electric grid. The powertrain has a machine driveshaft, the drive machine, a differential drive, and a differential transmission with three drives or outputs. One output connects to the driveshaft, a first drive connects to the drive machine, and a second drive connects to the differential drive. In a first phase, the drive machine starts up while one drive is simultaneously connected to the other drive or to the output, and the drive machine is separated from the grid. In a second phase, the drive machine connects to the grid, the connection between the one drive and the other drive or the output is separated, and the rotational speed of a drive/output is ascertained. The drive machine is connected to the grid if its rotational speed deviation from the grid frequency <±5.0%.

### CROSS-REFERENCE TO RELATED APPLICATIONS

This application is the U.S. national phase of International Application No. PCT/EP2020/086392 filed Dec. 16, 2020 which designated the U.S. and claims priority to AT Patent Application No. A 00400/2019 filed Dec. 16, 2019, the entire contents of each of which are hereby incorporated by reference.

### BACKGROUND OF THE INVENTION

### Field of the Invention

This invention relates to a method for connecting an electrical asynchronous machine of a drive train to an electrical grid, wherein the drive train has a drive shaft of a driven machine, the drive machine, a differential drive, and a differential transmission with three drives or outputs, of which one output is connected to the drive shaft, a first drive to the drive machine, and a second drive to the differential drive, wherein the drive machine is started up in a first phase from an rpm of zero or approximately zero, while a drive is connected simultaneously to the other drive or to the output, and the drive machine is separated in this phase from the grid, wherein in a second phase, the drive machine is connected to the grid, and the connection between one drive and the other drive or the output is separated, and wherein the rpm of at least one drive and/or output is determined.

In addition, the invention relates to a drive train with a drive shaft of a driven machine, with a drive machine, and with a differential transmission with three drives or outputs, wherein an output is connected to the drive shaft, a first drive is connected to the drive machine, and a second drive is connected to a differential drive, with a coupling, via which a drive is connected simultaneously to the other drive or to the output, with at least one device for detecting an rpm of at least one drive and/or output, and with a control for controlling the differential drive and optionally opening the coupling.

### DESCRIPTION OF THE RELATED ART

In WO 2016/172742 A1, a method for starting up a drive train with a differential system with a drive shaft of a driven machine, with a drive machine, and with a differential transmission with three drives or outputs is described, wherein one output can be connected to the drive shaft, a first drive to the drive machine, and a second drive to a differential drive. In this method, the differential system operates in a first phase in an operating mode I, in which a differential drive starts up an electrical drive machine and a driven machine or drives in the lower partial-load operational range until the drive machine has reached its connection rpm. The connection rpm is any rpm of a drive machine at which the latter is connected to the grid and which can vary depending on the specific design. The simultaneous acceleration of the driven machine and the drive machine is implemented by an additional connection. This additional connection is a gear box, via which, for example, the differential drive—in addition to its connection with the differential transmission—can be connected to the drive machine by means of a coupling. In a second phase, the drive machine is connected to the grid. In a third phase, in operating mode II, the system is operated in the differential mode up to a maximum torque or at maximum drive rpm.

If a synchronous three-phase machine is used as a drive machine, the latter is brought to its connection rpm and then, according to approved technological rules, is synchronized to the grid and switched smoothly to the grid. In this case, the differential drive helps to synchronize the drive machine to the grid, by the latter regulating the rpm and preferably also the phase angle of the drive machine and synchronizing with the grid. A synchronizing device in this case preferably measures the phase angle of the grid and drive machine and connects the latter as soon as the phase angle is essentially synchronous.

If the drive machine is designed as an asynchronous three-phase machine, the latter is brought to its connection rpm, then a power switch is closed, and thus the drive machine is connected to the grid. As soon as the latter is connected to the grid, it draws a high magnetization current for a short time. Moreover, the magnetization of the drive machine causes a brief drop in the speed of the drive machine, which is then raised again (because of the mass of inertia of the rotor of the drive machine) and levels off to its power- or slip-dependent operating speed.

Depending on the design and the type of drive machine and with a start speed equal to zero, the magnetization current can reach up to about 10 times the rated current of the drive machine. The level and period of the magnetization current depend, moreover, on whether a load (driven machine) is entrained upward or the rpm at which the drive machine is switched to the grid. If, as in the method proposed in WO 2016/172742 A1, no load is entrained upward from the drive machine, the level of the inrush current does not significantly change within the speed limits of, e.g., 90% up to 110% of the synchronous speed. Therefore, it is to be understood that according to the state of the art, no special precautions are taken during synchronization or switching to the grid of the asynchronous three-phase machine relative to the connection rpm.

It is described in DE 10 2016 213 639 A1 that when the rpm at the input shaft comes into the range of the rated rpm of the main drive machine, the latter can be switched to the electrical grid. In addition, it is described therein that it is advantageous when the drive device is designed in such a way that of the three speeds of the main drive machine, the output shaft and the auxiliary drive, at least two speeds are detected or measured. The third necessary rpm on the planetary gearing can be determined by the speed equations (Willis equations). The detection or measurement can be done in particular using pulse generators on the drive and/or speed sensors.

A control unit of the differential system sends a message to, for example, an overriding process control system as soon as the drive machine has reached its connection rpm. Subsequently, the coupling in the additional connection is preferably opened only after feedback from the process control system in the control unit is received, indicating that the drive machine is on the grid. In the meantime, the drive machine is, however, already connected to the grid—this delay can last several tenths of a second, optionally even several seconds. Preferably, here, as short a time span as possible is to be provided.

The differential drive operates for the purpose of connecting the drive machine preferably to rpm regulation. As soon as the drive machine is connected with a closed coupling, the differential system is tensioned. As result, initially the servo speed of the drive machine (because of the magnetization of the drive machine) and the driven machine is entrained downward (speed is lower), and a load-dependent operating speed of the drive machine is subsequently established, which in terms of slip is lower than its synchronous speed/rated rpm. If the connection rpm is significantly over-synchronous, the operating speed of the drive machine tends to drop further. If the connection rpm is clearly sub-synchronous, the operating speed of the drive machine tends to increase.

Synchronous connection rpm is defined as the rpm of the drive machine, which is derived based on the number of pole pairs of the drive machine and a current grid frequency. Thus, e.g., for a 4-pole three-phase machine, the synchronous connection rpm is 1,500 l/min at a rated grid frequency of 50 Hz, 1.485 l/min at a grid frequency of 49 Hz, and 1,800 l/min at a rated grid frequency of 60 Hz. A sub-synchronous connection rpm is lower and an over-synchronous connection rpm is higher than the synchronous connection rpm.

According to EN50160, the deviation of the grid frequency in grids with synchronous connection should be ±1% of 50 Hz. The grid frequency should deviate between +4% and −6% over a maximum of 0.5% of the year. In, e.g., Asian grids, these deviations can be larger.

In the case of the differential system according to the invention, deviations that are too large are not optimal in the case of the closed additional connection, since the differential system is tensioned, as soon as the drive machine is connected. As a result of the connection of the drive machine, major transient drive train stresses are therefore produced. This means, however, that the grid frequency at the time of the connection of the drive machine to the grid has a significant influence on the switching behavior (transition from operating mode I to operating mode II) of the differential system.

If an asynchronous three-phase machine is used as a drive machine in a differential system, it is therefore not optimal for the described reasons to accelerate the drive machine to a predefined connection rpm, in particular its rated rpm (e.g., detected by a speed sensor on the drive machine or derived by machine from the rpm of the differential drive), since here it cannot be ensured that the rpm of the drive machine is close enough to the actual grid frequency in order to ensure a smooth transition from operating mode I into operating mode II for the drive train.

### SUMMARY OF THE INVENTION

The object of the invention is to improve the connection of the driven machine to the grid, i.e., to reduce the load of the differential system.

This object is achieved with a method as disclosed and claimed.

This object is achieved in addition with a drive train as disclosed and claimed.

According to the invention, the grid frequency is detected, and the drive machine is only connected to the grid when the frequency produced from the rpm of the drive machine deviates by less than ±5% from the grid frequency, whereupon the connection between one drive and the other drive or the output is separated. To this end, the drive train has a device for detecting the grid frequency and a comparator in the control, which examines whether the frequency produced from the rpm of the drive machine deviates from the grid frequency by less than ±5%.

In this way, it can be prevented that the differential system is tensioned, as soon as the drive machine is connected, and major transient drive train stresses can be avoided.

Moreover, it makes a difference what type of coupling is used in the additional connection.

For free-wheeling couplings, the following applies: the further the connection lies within certain system-dependent limits in the sub-synchronous range, the lower the load of the differential drive and coupling and the more effectively the speed range of the differential drive can be used, since the latter starts at a lower rpm during the course of connecting the drive machine. According to the invention, it is therefore recommended when using a free-wheeling coupling to connect the drive machine sub-synchronously—preferably actual grid frequency −0.5% to −3.0%—to the grid. Because of the sub-synchronous connection, as soon as the drive machine is connected to the grid, it passes the differential-drive-side part of the free-wheeling coupling and thus automatically separates the additional connection between the drive machine and the differential drive.

Preferably, in this phase of the differential drive, the operation is performed with so-called rpm regulation—i.e., the process control system and/or the control device provide an rpm, and the regulation and control unit of the differential drive attempts to set this rpm as precisely as possible.

Because of the magnetization-induced drop in speed, i.e., the reduction of the rpm of the drive machine while it is being connected to the grid, the rpm of the differential drive and the driven machine are also initially entrained downward. As soon as the feedback “drive machine on the grid” is received preferably in the control unit, the rpm specified in the differential drive by its control is reduced and by means of the downstream torque regulator changes the direction of the torque (by, e.g., field vector regulation of the convertor) from a motor quadrant into a generator quadrant. During the connecting process, preferably (but in no way necessarily) a monitoring and/or limiting of the design-specific maximally-allowed current (primarily for the convertor) is in effect.

In a preferred embodiment of the invention, the rpm that is supplied to the differential drive by a control is therefore adapted accordingly with a reduction of the rpm of the drive machine as a result of its connection with the grid in order to ensure as low a load on the differential drive as possible. It is preferably detected whenever the drive machine was actually connected to the grid, and then the rpm that is supplied to the differential drive by the control is adapted accordingly with the reduction of the rpm of the drive machine as a result of its connection with the grid. Finally, the direction of the torque of the differential drive is then changed, and the coupling is opened. Also, this embodiment of the invention can be used in isolation from the invention in question, i.e., the adaptation of the frequency of the drive machine to the grid frequency and the subsequent separation of the connection between one drive and the other drive or the output, and thus represents a separate invention and the possibility of protecting the drive train from an excessively high tensioning or transient oscillations.

As an alternative, the torque (without further active influence on the rpm thus to be adjusted) can also be regulated by means of torque regulation (i.e., the process control system and/or the control device provide torque) from a motor quadrant into a generator quadrant, and the differential system subsequently operates in operating mode II. In this case, preferably (but in no way necessarily) monitoring and/or limiting of the design-specific maximally-allowed rpm (primarily for the differential drive) is also in effect here. Also, this represents a separate invention and the possibility of protecting the drive train from an excessively high tensioning or transient oscillations.

For the record, in general, a change from the regulating mode of rpm regulation to the regulating mode of torque regulation or a change of parameterized preset speed and torque values/limits is typically carried out (i.e., in the case of commercially available industrial power units) in approximately 20 to 40 milliseconds [ms]. This time span is derived from the cycle times of the control unit of the differential system or the regulation of the converter. Thus, very fast transient changes of state can be only conditionally (i.e., depending on the achievable cycle times) compensated for by switching the regulation mode. In this case, no limits are set here with regard to even shorter cycle times, and a reasonable compromise must be struck between measuring technology and control device expense and achievable load reduction.

If a free-wheeling coupling is provided in the additional connection, this coupling opens automatically because of the torque directional change.

If a shifting clutch is provided in the additional connection instead of a free-wheeling coupling, this coupling is not opened automatically. A first approach to regulation of the differential system is in this case to continue the rpm regulation that is in effect at this time. Because of a drop in the speed of the drive machine while it is being connected to the grid, the differential drive changes—by means of its torque regulator (downstream from the rpm regulator)—the direction of the torque (by, e.g., field vector regulation of the frequency converter) from a motor quadrant into a generator quadrant, and a generator torque is subsequently set. In this case, the motor torque is first regulated toward zero, before it changes in the generator quadrant.

According to the invention, as an alternative, the rpm of the drive machine and/or driven machine and/or differential drive can be monitored, and the rpm of the differential drive can be “updated” corresponding to the connection-induced fluctuation of the rpm of the drive machine. In this case, connection times and drops in speed that are typical according to the invention can be calculated and/or detected by measuring technology and preferably “held”—i.e., a drop in speed on the differential drive can be compensated for with a (±) delay that is typical of a coupling or drive machine.

According to the invention, as an alternative, the torque (without further active influence on the rpm thus to be adjusted) can also be regulated by means of torque regulation from a motor quadrant into a generator quadrant, wherein the system then subsequently operates in operating mode II.

Consequently, in an embodiment of the method according to the invention, the direction of the torque of the differential drive in the case of a reduction in the rpm of the drive machine is changed as a result of its connection with the grid. In this case, it is preferably detected whenever the drive machine was actually connected with the grid, and then the direction of the torque of the differential drive is changed. In this case, the coupling is opened. Also, this embodiment of the invention can as well be isolated from the invention in question, i.e., the adaptation of the frequency of the drive machine to the grid frequency and the subsequent separation of the connection between one drive and the other drive or the output can be used and thus represents a separate invention and the possibility of protecting the drive train from an excessively high tensioning or transient oscillations.

In still another variant according to the invention, the torque of the differential drive is preferably kept essentially constant at the initial moment of the connection, and in still another variant embodiment, starting at the time of the input of the feedback in the control unit that the drive machine is on the grid, it is regulated toward zero. This is used to keep the load as low as possible in the additional connection and here in particular for the coupling, before the latter is opened.

In general, when using shifting clutches, the following applies: the closer the connection is made to the synchronous speed, the more effectively the speed range of the differential drive can be used, with the load of the coupling and differential drive simultaneously being as low as possible. In addition, the following applies for shifting clutches: the further the connection is made within certain system-dependent limits in the sub-synchronous range, the higher the system loads—primarily for the coupling.

For this reason, the shifting clutch according to the invention is also preferably designed to be torque-limiting (e.g., as a multi-disk clutch with friction pads).

In any case, the connection of an asynchronous machine as a drive machine causes significant transient drive train oscillations. In order to avoid in this case a major overshooting of the torque in the drive train and in particular in the additional connection, it is therefore recommended according to the invention that the drive machine be switched to the grid as synchronously as possible. In this connection, small rpm differences make a major difference relative to (a) a smooth transition between operating mode I and operating mode II (e.g., the smallest possible rpm fluctuations for the pump) or (b) the load of the system resulting therefrom.

For this reason, in the case of the invention, the acceptable deviation of the connection rpm or the frequency of the drive machine being produced therefrom is at maximum ±5.0%, in a preferred variant embodiment at maximum ±3.0%, in an especially preferred variant embodiment at maximum ±2.0%, and in particular at maximum ±1.0% of the actual grid frequency. In this case, no limits are set here with regard to still higher accuracy, and a reasonable compromise must be struck between measuring technology and control device expense and achievable load reduction.

In order to meet the connection conditions, the grid frequency is detected in a variant embodiment according to the invention. In this case, preferably the following methods can be used.

Precise detection of the grid frequency can preferably be carried out, on the one hand, by means of a technically suitable measuring device (e.g., any type of grid-frequency-measuring device), which forwards the actual measured grid frequency to the control unit. In a variant embodiment according to the invention, the grid frequency detected by the converter of the differential drive is forwarded to the control unit. Thus, preferably the control unit can perform a very precise situationally-adapted calculation of the required connection rpm of the drive machine. Thus, the desired range of the connection rpm of the drive machine can be selected to be very small.

On the other hand, in many cases, it is enough to detect as precisely as possible the rpm of at least one of the drives or the output. A desired connection rpm of the drive machine can in this case be determined, e.g., by using typical values of the grid frequency-fluctuation range, and on this basis a desired connection rpm of the drive machine being determined. Typical values of the grid frequency-fluctuation range can in this case be, e.g., statistical values from historical databases, or can be determined based on field campaigns. From these statistical data, e.g., a range is then determined, within which preferably lie, e.g., 90% of the grid frequencies that occur in the existing grid. This range is used for further determination of the boundary values for the connection rpm of the drive machine.

Examples of an exemplary typical grid frequency-fluctuation range (bandwidth) of ±1.0% are:
(a) If a range of the desired connection rpm of a maximum of ±3.0% is selected, in this example, the boundary values for the connection rpm of the drive machine are established within ±2.0% of the synchronous speed of the drive machine.
(b) If a range of the desired connection rpm of −0.5 to −3.0% is selected, in this example, the boundary values for the connection rpm of the drive machine are established within −1.5 to −2.0% of the synchronous speed of the drive machine.

In order to be able to maintain the described specifications relative to the acceptable deviation of the connection rpm, a lowest possible speed tolerance is preferably to be ensured. The speed tolerance is determined by, i.a., a high resolution or precision of the measuring chain, beginning with the frequency measurement or the speed detection via the processing of the measuring signal by means of a control unit up to the rpm regulation of the differential drive. In a drive system (electric motor and converter) according to the state of the art, in this case, a maximum deviation (speed tolerance) between the actual measured grid frequency or rpm and the connection rpm of ±0.1% that is set on the drive motor is desired. In this case, no limits are set on precision deviating therefrom, and a reasonable compromise must be struck between measuring technology and control device expense and achievable load reduction.

The described speed tolerance is also to be subtracted from the boundary values of the connection rpm of the drive machine. That is to say that with a speed tolerance of ±0.1%, the boundary values in the above-shown Example (a) are reduced from ±2.0% to ±1.9% or in Example (b) from −1.5 to −2.0% to −1.6 to −1.9% of the synchronous speed of the drive machine.

Assuming that the speed tolerance is ±0.1%, in the detection of the grid frequency, the best-possible selectable range of the connection rpm is ±0.1%.

Preferred embodiments of the invention are also disclosed.

### BRIEF DESCRIPTION OF THE DRAWINGS

Below, preferred embodiments of the invention are explained relative to the accompanying drawings. Here:

FIG. 1 shows the principle of a differential system with an additional connection for a drive of a pump according to the state of the art,

FIG. 2 shows a diagram with a typical regulation systematization of a regulation and control unit of a speed-variable drive,

FIG. 3 shows an embodiment, according to the invention, of a differential system, and

FIG. 4 shows a sequence for a connection of a drive machine of a differential system.

### DESCRIPTION OF THE PREFERRED EMBODIMENTS

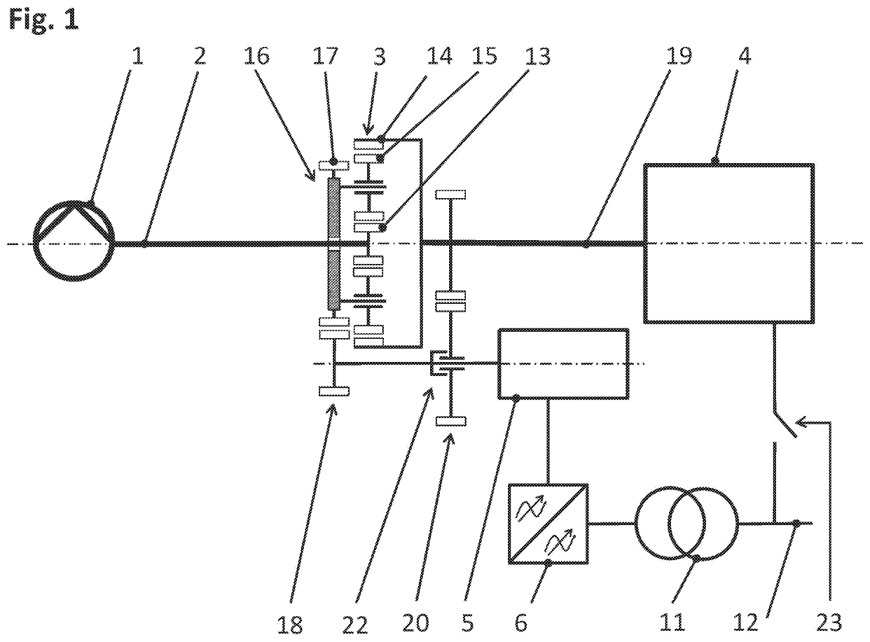

FIG. 1 shows the principle of a differential system with an additional connection for a drive of a pump according to the state of the art. The depicted drive train consists of a powered driven machine 1 (in this example, i.e., the pump), a drive shaft 2, a drive machine 4, and a differential drive 5, which are connected with the output or drives of a differential transmission 3. The differential drive 5 is connected to a grid 12 by means of a converter 6 (consisting of preferably motor-side and grid-side inverters or rectifiers—depicted simplified here as a unit) and a transformer 11.

The drive machine 4 can be connected to the grid 12 by means of a switch 23. The drive machine 4 is preferably a medium-voltage three-phase machine, which is connected to the grid 12, which in the example that is shown is a medium-voltage grid based on a medium-voltage three-phase machine. The selected voltage level depends on the application and primarily on the performance level of the drive machine 4 and can have any desired voltage level without affecting the basic function of the system according to the invention. According to the number of pole pairs of the drive machine 4, a design-specific operating speed range is achieved. The operating speed range is any speed range in which the drive machine 4 can deliver a defined or desired or required torque and in which the electrical drive machine 4 is connected to the grid or can be synchronized with the grid 12.

The differential drive 5 is preferably a three-phase machine and in particular an asynchronous machine or a permanent-magnet-excited synchronous machine.

Instead of the differential drive 5, a hydrostatic control gear can also be used. In this case, the differential drive 5 is replaced by a hydrostatic pump/motor combination, which is connected to a pressure line and can be adjusted preferably in the flow volume. Thus, as in the case of a variable-speed, electrical differential drive 5, the rpm can be regulated.

In this embodiment, the core of the differential system is thus a simple planetary gearing stage with three drives or outputs, wherein an output is connected to the drive shaft 2 of the driven machine 1, a first drive is connected to the drive machine 4, and a second drive is connected to the differential drive 5. A significant advantage of this design is that the drive machine 4 can be connected directly, i.e., without expensive power electronics, to the grid 12. The equalization between the variable rotor speed and the set rpm of the grid-bound drive machine 4 is provided by the speed-variable differential drive 5.

With an rpm, determined by the drive machine 4, of the internal gear 14 that is connected to the drive machine 4 and an operation-induced required rpm of the sun wheel 13 that is connected to the driven machine 1, an rpm that is to be adjusted or torque that is to be adjusted is necessarily produced on the planetary carrier 16 that is connected to the differential drive 5, which carrier can be regulated by the differential drive 5. The torques on the outputs and drives are proportional to one another, ensuring that the differential drive 5 is also able to regulate the torque in the entire drive train.

The power input or output of the differential drive 5 is essentially proportional to the product that consists of the percentage of deviation of the rpm of the driven machine 1 from its base rpm, multiplied by the power of the driven machine 1. The base rpm is in this case the speed that is set on the driven machine 1 when the differential drive 5 has an rpm that is equal to zero. Accordingly, a large operating speed range of the driven machine 1 requires a correspondingly large sizing of the differential drive 5. If the differential drive 5 has, for example, a nominal power of approximately 20% of the system's entire power (a nominal power of the driven machine 1), this means—using a so-called field weakening range of the differential drive 5—that minimum operating speeds of approximately 50% of the operating nominal rpm can be produced on the driven machine 1. The rpm on the drives and outputs of the differential system are determined by the speed ratios of the differential gear 3 and the adjusting gear unit or the adjusting gear units that are downstream from the latter. On this basis, and on the basis of the required work rule range of the driven machine 1, the required governed speed range of the differential drive 5 and the converter 6 is subsequently obtained. The governed speed range is in this case determined primarily by the parameters that are specified by the manufacturer, such as voltage, current and rpm limits, field weakening range, overload capacity, etc.

Due to the fact that in most cases a higher percentage of overspeed (because of mechanical requirements) is achieved by default with higher-pole three-phase machines, in most cases a larger field weakening range can be produced with higher-pole three-phase machines. This has a correspondingly positive effect on the sizing of the differential drive 5 and the converter 6.

Since, in the embodied example, the driven machine 1 is operated at a speed that is significantly above the synchronous speed of the drive machine 4, the drive shaft 2 is connected to the sun wheel 13, and the drive machine 4 is connected to the internal gear 14 by means of a connecting shaft 19. The planetary carrier 16 (with two or more planetary wheels 15) can be connected to the differential drive 5 (“Variant 5” in the table below). Thus, a speed ratio between the drive machine 4 and the driven machine 1 of, for example, 2.5 to 7.5, in particular up to 6.5, can be achieved in a simple way with a planetary gearing stage and without an optional adjusting gear unit. Moreover, significantly higher speed ratios can be achieved with, for example, a stepped planetary set. A stepped planetary set is characterized in that the planetary wheels 15 in each case have two gears, which are connected to one another in a torque-proof manner and have different pitch-circle diameters, wherein one gear interacts with the sun wheel, and the second gear interacts with the internal gear.

The following table shows possible combinations of the coupling of the planetary carrier 16, the sun wheel 13, and the internal gear 14 to the rotor 1 [R], the differential drive 5 [D], and the drive machine 4 [A], which are all covered according to the invention:

| Variant | 1 | 2 | 3 | 4 | 5 | 6 |
|---|---|---|---|---|---|---|
| Sun Wheel 13 | D | A | R | D | R | A |
| Planetary Carrier 16 | R | R | A | A | D | D |
| Internal Gear 14 | A | D | D | R | A | R |

The planetary carrier 16 can be designed, for example, as a one-piece or multi-piece unit with components that are connected to one another in a torque-proof manner. Since the torque on the planetary carrier 16 is high, it is advantageous to implement, e.g., a transmission stage 17, 18 between the planetary carrier 16 and the differential drive 5. For this purpose, an adjusting gear unit is offered, e.g., in the form of a straight-cut, helical-cut or herringbone-cut spur gear stage, wherein one gear 17 is connected to the planetary carrier 16 in a torque-proof manner, and the other gear 18 is connected to the differential drive 5. Instead of the adjusting gear stage 17, 18, however, e.g., a multi-stage straight-cut, helical-cut or herringbone-cut spur gear, a planetary gear or a bevel gear, a chain drive, a V-belt drive, a control gear, etc., or a combination of these types of gears can also be used.

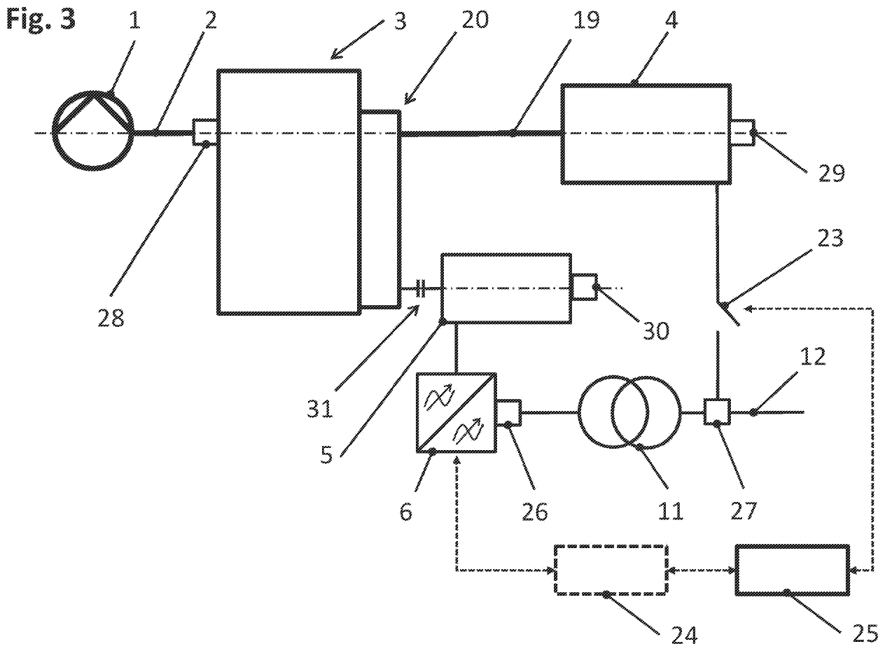

A pump is depicted symbolically by way of example as driven machine 1 in FIGS. 1 and 3. The principles described above and below can also be used, however, in the case of drives for other driven machines, such as, e.g., compressors, fans, conveyor belts, mills, crushers, and the like.

FIG. 1 shows a differential drive 5 with a converter 6. Also, multiple differential drives 5 can drive the planetary carriers 16, by which means the torque of the adjusting gear stage 17, 18 that is to be transferred is distributed to these differential drives 5. The differential drives 5 can in this case be distributed uniformly or else asymmetrically around the periphery of the gear 17. Preferably—but not necessarily—the differential drives 5 are controlled in this case by a common converter 6, wherein then preferably a differential drive 5 acts as a so-called “master” and the other differential drive(s) 5 act(s) as (a) so-called “slave(s).” The differential drives 5 can also be actuated by multiple motor-side inverters 6 individually or in groups, wherein the latter have motor-side inverters 6 connected to the differential drives 5, grid-side rectifiers, preferably a common one that is connected via a transformer 11 to the grid 12, to which rectifiers they are connected via a direct current link.

An additional connection 20 is connected to the connecting shaft 19 and subsequently to the drive machine 4 or the first drive of the differential system. This additional connection 20 can be connected to the differential drive 5 by means of a coupling 22. The coupling 22 can in principle be positioned anywhere in the power flux between the differential drive 5 and the first drive of the differential system, i.e., also in a different stage of the additional connection 20 than that closest to the differential drive 5. The coupling 22 is preferably implemented as a shifting clutch, e.g., in the form of a claw coupling, geared clutch, or multi-disk clutch, or as a free-wheeling coupling.

A free-wheeling coupling (also referred to as an overrunning clutch) is in this case a coupling that acts only in a direction of rotation. The free-wheeling coupling can also be implemented in the form of a self-synchronizing shifting clutch. This is a free-wheeling coupling, in which in the fully-activated state, the torque transfer is carried out via a geared clutch.

The drive machine 4 can also be connected to a gear-intermediate stage of the additional connection 20, wherein the connection of the additional connection 20 to the first drive continues to exist.

When the system is equipped with multiple differential drives 5, preferably only one differential drive 5 is connected to the drive machine 4 via an additional connection 20. In this case, at least one second differential drive 5 in addition to the first differential drive 5 drives the additional connection 20 via the planetary carrier 16 and the adjusting gear stage 17, 18. Thus, only one additional connection 20 is necessary. As an alternative, multiple differential drives can also be connected in parallel by means of a separate additional connection 20 with, e.g., the drive machine 4. As additional alternatives, the drive machine 4 can also be connected to the drive shaft 2 by means of an additional connection.

In order to start up the system, the differential drive 5 is connected to the additional connection 20 by closing the coupling 22. The driven machine 1 and the drive machine 4 are thus also accelerated by the differential drive 5 that is then run up. In the event of the coupling 22 being implemented in the form of a free-wheeling coupling, the latter automatically transfers the rotational movement of the differential drive 5 to the additional connection 20 or the drive machine 4. In this case, the differential system operates in the so-called start-up mode (operating mode I).

The drive machine 4 is preferably brought to operating speed and then the switch 23 is closed and the drive machine 4 is connected to the grid 12. This briefly draws a magnetization current when it is connected to the grid 12. The latter is higher than the rated current of the drive machine 4, but queues up only for a few grid periods and lies below the current intensity that is set and that the drive machine 4 would draw if the latter is switched onto the grid under load. This magnetization current can in addition be reduced, if necessary, by using approved technical methods.

At the same time or subsequently, the coupling 22 is opened, and the differential system operates in the so-called differential mode (operating mode II). If the coupling 22 is implemented as a free-wheeling coupling, the connection breaks off automatically as soon as the rpm of the driving part (differential drive 5) is smaller than the rpm of the part that is to be driven (additional connection 20).

In the event of a breakdown (e.g., blackout, system error, overload, etc.), both the drive machine 4 and the driven machine 1 spin down in an uncontrolled manner. In such a case, in order to protect from overspeed the differential drives 5 that operate in the differential mode, a brake (not shown) that acts on the second drive of the differential system or on the differential drive 5 can be used. As an alternative solution, it is advisable to open a coupling (not shown) that is implemented between the differential drive 5 and the second drive of the differential system and thus to separate the differential drive(s) 5 from the remaining differential system.

If the coupling 22 is implemented as a free-wheeling coupling, its connection is automatically activated as soon as the rpm of the driving part (additional connection 20) would be smaller than the rpm of the part to be driven (differential drive 5), ensuring that overspeed of the differential drive 5 is inherently prevented.

If the coupling 22 is implemented as a shifting clutch, the latter—in the event of a breakdown—is preferably activated when the rpm difference between the output shaft of the additional connection 20 and the differential drive 5 is a minimum (ideally at an rpm difference of approximately zero).

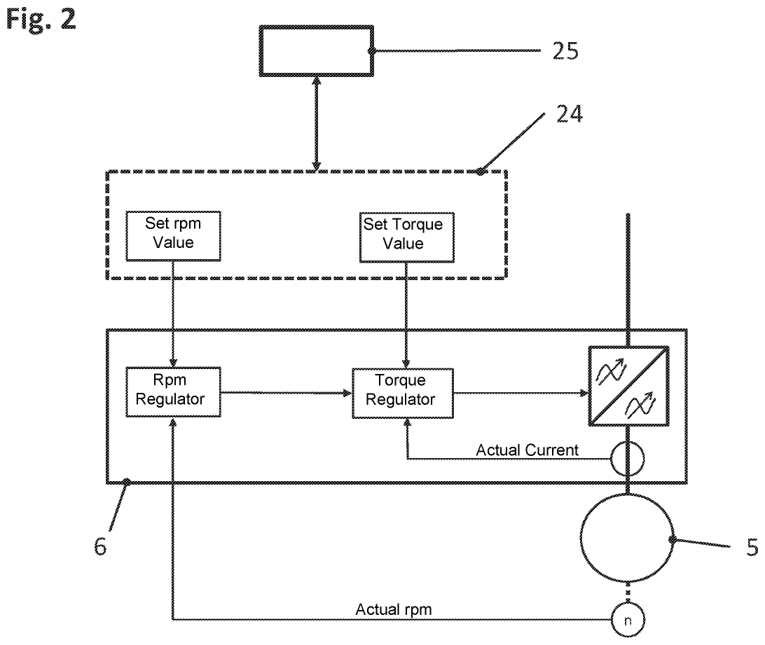

FIG. 2 shows a diagram with an illustrative regulation diagram of a regulation and control unit of a speed-variable drive of a differential system.

A control unit 24 regulates and controls the functions of the differential system. The latter communicates with an overriding process control system 25. Via this communication interface, i.a., process-relevant status messages and setpoint settings are exchanged. The control unit 24 communicates via another interface with the converter 6. Also, via this other communication interface, i.a., process-relevant status messages and setpoint settings are exchanged. Preferably, the control unit 24 makes decisions via the regulating mode (i.e., between rpm regulation and torque regulation) or a change in parameterized torque values/limits. The control unit 24 can also be part of the converter 6. That is to say, the control and regulation unit of the converter 6 also takes over the functions of the control unit 24 and the communication to the process control system 25.

By actual-current monitoring of the control unit 24 or the converter 6, the maximum allowed current intensity for the converter 6 and the differential drive 5 and thus the maximum acceptable torque are monitored or limited.

In the case of an rpm regulation, the converter 6 preferably detects the rpm n of the differential drive 5 (e.g., by means of an rpm-measuring device), compares the latter in the rpm regulator to the set rpm value, and increases or reduces the torque by means of a downstream torque regulator in order to achieve the preset rpm. In this case, preferably (but in no way necessarily) a monitoring and/or limiting of the design-specific maximally-allowed current intensity that is set (primarily for the differential drive 5 or converter 6) is in effect. That is to say, the maximally-allowed current intensity (taking into consideration an overload that is optionally acceptable for a limited time) is achieved, the set rpm value cannot be reached, and an rpm that can be reached based on the maximally-acceptable current intensity is set.

By means of so-called field vector regulation, the control and regulation device of the converter 6 can regulate the torque of the converter 6 in four so-called quadrants, ensuring that depending on the direction of rotation, a generator or motor torque can be set in each case. In addition, the differential drive 5 can also be operated over-synchronously in the so-called field weakening range by means of its converter 6. Typically, this over-synchronous range is limited because of mechanical limits of the differential drive 5, wherein the overspeed limits are usually lower as system size increases.

FIG. 3 shows an embodiment, according to the invention, of a differential system. In principle, the differential system is designed the same as described in FIG. 1. The drive train also consists here of a driven machine 1, a drive shaft 2, a differential transmission 3, an additional connection 20, a motor shaft 19, a drive machine 4, a differential drive 5, and a converter 6. The differential drive 5 is in this case connected to the additional connection 20 by means of an especially flexible, i.e., torsional-vibration-damping coupling 31. By decreasing the stiffness of the coupling 31, the connection-induced drive-train load transients can be correspondingly reduced.

As an alternative to the connection of the differential drive 5 and the drive machine 4 by means of the additional connection 20, the system according to the invention also functions with one or more additional connection(s) between the differential drive(s) 5 and the driven machine 1 or between the drive machine 4 and the driven machine 1.

As described in FIG. 2, the control device 24 communicates with the converter 6 and the process control system 25. The process control system 25 controls, i.a., the switch 23, in order to connect the drive machine 4 to the grid 12 or to separate the latter from the grid 12. As an alternative, this can also be controlled by the control device 24 or the converter 6. According to the invention, in the embodiment of FIG. 3, optionally various measuring devices 26, 27 for detecting the grid frequency of the grid 12 (grid frequency measuring device) are implemented. These measuring devices can be integrated into, e.g., the converter 6 (measuring device 26), but also can be positioned at any other position at which the actual grid frequency can be detected, such as in, e.g., the medium-voltage grid 12 (measuring device 27). By precise detection of the actual grid frequency, it is possible to adapt the connection rpm of the drive machine 4 as precisely as possible to the actual grid frequency and thus to avoid unwanted high loads, e.g., drive train oscillations, when the drive machine 4 is connected.

In order to be able to adapt the rpm of the differential drive 5 during the connection of the drive machine 4 to the rpm regime of the drive machine 4, for example, there can be one or more rpm measuring devices 28, 29, and 30 on the drives and outputs of the differential system. In this case, in principle, only one rpm measuring device—preferably the rpm measuring device 30—is necessary, since the other rpm can be derived therefrom. In another embodiment, the rpm measuring device 30 can be replaced by a calculation of the rpm in the motor-side inverter of the converter 6—e.g., based on a so-called sensor-less rpm regulation.

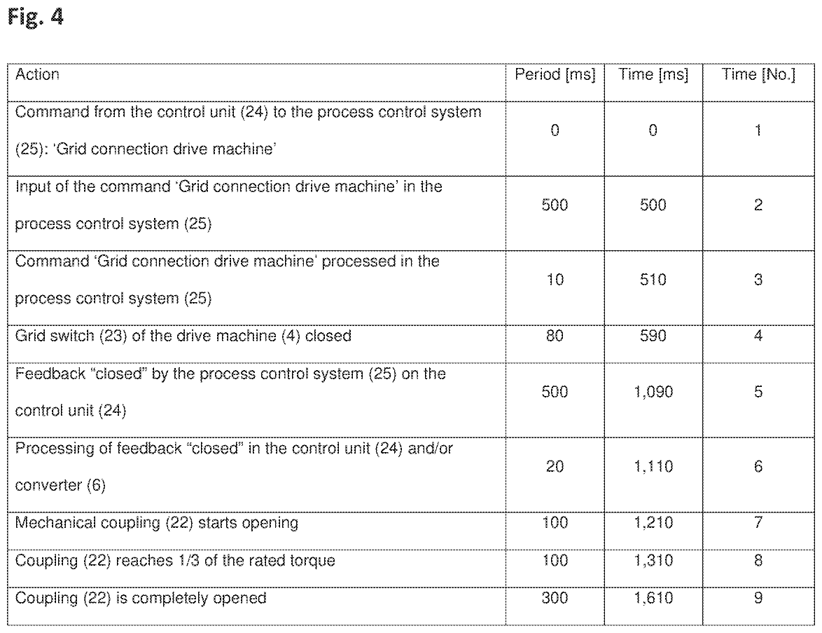

FIG. 4 shows a sequence for the start-up and subsequently the connection of the drive machine 4 of a differential system to the grid 12 in the example of a steam power plant.

Typically, a steam power plant is controlled by a process control system 25. In this case, this process control system 25 also controls the connection of a drive machine 4 to a boiler feed pump as a driven machine 1 and connects the drive machine 4 to the grid 12 by means of the switch 23. The process control system 25 in this case preferably communicates with the control unit 24.

In the case of the example “differential system as rpm-variable drive of a boiler feed pump,” the connecting process can, for example, proceed according to the following chronology:

The drive machine 4 is accelerated first as described with the aid of the differential drive 5. After the drive machine 4 has reached its connection rpm, the control unit 24 sends the command ‘grid-connection drive machine’ to the process control system 25 at time 1. Due to a system-induced delay in the communication interface, this command enters the process control system at time 2.

Subsequently, this command is processed at time 3 in the process control system, and the command “close grid switch” is directed to the grid switch 23. This process “close grid switch” lasts approximately 80 ms and is terminated at time 4, i.e., after a total of 590 ms from the start of the connecting process.

Then, the process control system 25 notifies the control unit 24 “to close the grid switch.” This is executed at time 5. Subsequently, this message is processed in the control unit until time 6, and a corresponding command is forwarded to the coupling 22. Based on typical, system-induced boundary conditions, the coupling 22 is to start opening only at time 7 (after approximately 100 ms). If the coupling is, e.g., a standard multi-disk clutch, the transferable torque is dropped to about ⅓ by time 8 (after, e.g., 100 ms), and the coupling is to be completely opened at time 9 (after, e.g., another 300 ms). The complete switching process thus lasts approximately 1.6 seconds.

The time sequences depicted in FIG. 4 are an example and can deviate significantly from the processes and time sequences shown in both an operation-induced and a system-induced manner. That is to say, certain sequences can last much longer; however, according to the invention, they can also be shortened or bypassed.

According to the above-described connecting process, between the times “1” and “6,” the system control (in the control device of the differential system) does not know whether or exactly when the drive machine is or was connected. That is to say, the differential system remains “tensioned” over a more or less extended period and thus stressed with transient drive train oscillations.

According to the invention, in this connection, an improvement is to be achieved by ensuring that the rpm of the drive train, i.e., the driven machine 1 and/or the drive machine 4 and/or the differential drive 5, is monitored in the connecting phase by means of an rpm measuring device 28, 29, 30 (and/or an rpm from which the connection-induced drop in rpm can be derived) or that a desired nominal rpm for the differential drive 5 is accordingly derived therefrom. This desired nominal rpm is preferably calculated from the rpm of the drive train and the speed ratios of the differential transmission 3 plus possible implemented adjusting gear stages.

1. Method for connecting an electrical three-phase machine as a drive machine of a drive train to an electrical grid,
wherein the drive train has a drive shaft of a driven machine, the drive machine, a differential drive, and a differential transmission with three drives or outputs,
of which one output is connected to the drive shaft, a first drive to the drive machine, and a second drive to the differential drive,
wherein the drive machine is started up in a first phase from an rpm of zero or approximately zero, while a drive is connected simultaneously to the other drive or to the output, and the drive machine is separated in this phase from the grid,
wherein in a second phase, the drive machine is connected to the grid, and the connection between one drive and the other drive or the output is separated,
and wherein the rpm of at least one drive and/or output is determined,
wherein
the grid frequency is detected in particular by measuring technology, or a grid frequency-fluctuation range is defined,
wherein the drive machine is connected to the grid when the frequency produced from the rpm of the drive machine deviates by less than ±5.0% from the grid frequency,
and wherein the connection between one drive and the other drive or the output is separated.

2. The method according to claim 1, wherein the drive machine is connected to the grid when the frequency that is produced from the rpm of the drive machine deviates from the grid frequency by less than ±3.0%.

3. The method according to claim 1, wherein the rpm of at least one drive and/or output is measured.

4. The method according to claim 1, wherein the coupling is a torque-limiting coupling.

5. The method according to claim 1, wherein the differential drive is an electrical machine that is connected to the grid via a converter.

6. The method according to claim 5, wherein the rpm of the drive machine is derived from values of the regulation of the converter.

7. The method according to claim 5, wherein the converter of the differential drive determines the grid frequency.

8. The method according to claim 1, wherein the grid frequency is measured by means of a grid-frequency-measuring device.

9. The method according to claim 1, wherein the phase angle of the electrical machine is synchronized with the grid by means of the differential drive before the drive machine is connected to the grid.

10. The method according to claim 9, wherein at the same time or subsequently, the direction of the torque of the differential drive is changed.

11. The method according to claim 1, wherein the direction of the torque of the differential drive is changed in the case of a reduction of the rpm of the drive machine as a result of its connection to the grid.

12. The method according to claim 11, further comprising detecting whenever the drive machine was actually connected to the grid and wherein then the direction of the torque of the differential drive is changed.

13. The method according to claim 1, wherein one drive in the first phase is connected via a free-wheeling coupling to the other drive or to the output, which automatically opens in the case of a torque of approximately zero or a change in the direction of the torque.

14. The method according to claim 1, wherein one drive in the first phase is connected via a shifting clutch to the other drive or to the output, and wherein the shifting clutch is opened at a torque of approximately zero.

15. The method according to claim 1, further comprising detecting whenever the drive machine was actually connected to the grid, and wherein the torque of the differential drive is kept constant until this time.

16. The method according to claim 1, further comprising detecting whenever the drive machine was actually connected to the grid and wherein then the torque is reduced to zero.

17. Drive train with a drive shaft of a driven machine, with a drive machine and with a differential transmission with three drives or outputs,
wherein an output is connected to the drive shaft, a first drive is connected to the drive machine, and a second drive is connected to a differential drive,
with a coupling, via which a drive is connected simultaneously to the other drive or to the output,
with at least one device for detecting an rpm of at least one drive and/or output,
and with a control for controlling the differential drive,
further comprising
device for detecting the grid frequency being provided,
and a comparator in the control, which examines whether the frequency of the grid frequency produced from the rpm of the drive machine deviates by less than ±5.0%.

18. The drive train according to claim 17, wherein the comparator examines whether the frequency that is produced from the rpm of the drive machine deviates from the grid frequency by less than ±3.0%.

19. The drive train according to claim 17, wherein the coupling is a claw coupling, geared clutch, free-wheeling coupling, or multi-disk clutch.

20. The drive train according to claim 17, wherein the coupling is a torque-limiting coupling.

21. The drive train according to claim 17, wherein the coupling is a hydrodynamic coupling.

22. The drive train according to claim 17, wherein the differential drive is a three-phase machine.

23. The drive train according to claim 17, wherein the differential drive is a hydrostatic pump/motor combination.

24. The drive train according to claim 17, wherein the differential transmission is a planetary gearing.

25. The drive train according to claim 17, wherein the driven machine is a pump, a compressor, fan, conveyor belt, crusher, or a mill.
